(19) United States
(12) Patent Application Publication
(10) Pub. No.: US 2006/0113809 A1
(43) Pub. Date: Jun. 1, 2006

(54) Device for partitioning off a trunk space

(75) Inventors: Thomas Heckmann, Aidlingen (DE); Juergen Schrader, Weil im Schonbuch (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/083,956

(22) Filed: Mar. 21, 2005

(30) Foreign Application Priority Data
Nov. 27, 2004 (DE) 10 2004 057 399.9

(51) Int. Cl. B60J 7/20

(52) U.S. Cl. 296/24.4

(57) ABSTRACT

A device for partitioning off a trunk space, in particular of a convertible, which has a folding top (11) which can be retracted below a trunk lid (12). The device includes a fixed partition element (10), which can be displaced by means of at least one lever between an upper position for loading the trunk space, and a lower position for putting the folding top away. The partition element (10) can be removed from the trunk space (13) without any tools.

This application claims the priority of German application no. 10 2004 057 399.9, filed Nov. 27, 2004, the disclosure(s) of which is (are) expressly incorporated by reference herein.

### BACKGROUND AND SUMMARY OF THE INVENTION

The invention relates to a device for partitioning off a trunk space.

Motor vehicles having retractable folding tops are known in the case of convertibles. Folding tops of convertibles usually consist either of fabric with a corresponding linkage, or they are formed as “hard tops”, i.e. from firm elements. In the open state the folding top is stowed or concealed in a folding-top compartment. The folding-top compartment is usually arranged in the region of a vehicle rear as part of a rear stowage space. The folding-top compartment causes the rear stowage space to be reduced by the volume of the folding-top compartment. As a result, the loading capacity in the rear stowage space is considerably restricted, and it is sometimes difficult to stow large items of luggage in convertibles. However, a separation of folding-top compartment and trunk space is desirable in order to protect the folding top from possible damage by loaded items.

German patent specification DE 198 45 154 C2 provides a fixed partition element which is designed as an intermediate wall and divides the rear stowage space into a front folding-top compartment and a trunk space situated behind it. In order, when the folding top is closed, to enlarge the trunk space if the need arises, it is proposed to displace the partition element into an upper position for loading the trunk space by enabling side walls to be pivoted away via a lever. In an open state or with the folding top put away, the partition wall can be displaced again into a lower position for putting the folding top away. The partition wall is used to protect the folding top which has been put away against being damaged by the luggage in the trunk space. However, the provided partition wall, both in its upper position and in its lower position, considerably reduces the volume, which is in any case restricted, in the rear stowage space.

The invention is based on the object of providing an improved device for partitioning off a trunk space, in which a stowage capacity which is as large as possible is made available in the rear stowage space.

In the case of the device according to the invention, the partition element can be removed from the trunk space without any tools. When the folding top is closed, for example in winter, the partition wall is not required in any case. When the folding top is closed, the partition wall is also not required as a means of protecting the put-away roof against being damaged. Removal of the partition wall therefore makes it advantageously possible to greatly enlarge the trunk capacity in a simple manner. Removal of the partition wall expediently also does not require a great technical fitting outlay, since the partition wall can be removed without a tool.

Expedient refinements and advantages of the invention can be gathered from the description and the further claims.

The partition element is expediently fastened in the trunk space by means of a fastening device, one part of the fastening device being fitted in a manner such that it is secured on the vehicle and another part of the fastening device such that it is secured on the partition element. The fastening device, in the installed position, is preferably arranged in each case laterally in trunk walls. The fastening device can be operated in each case easily by one hand, with the result that an insertion or removal of the partition element can be carried out easily and rapidly.

That part of the fastening device which is fitted in a manner such that it is secured on the vehicle can be arranged directly on the body. It is required for a region of the interior lining of the trunk space to be removed in order to permit access to this part of the fastening device and installation of the partition wall. In order to prevent this problem, when the partition wall is removed, an unattractive opening remains in the interior lining, the latter can advantageously be covered by a pocket matched to the interior lining. The said pocket is preferably configured in such a manner that the opening is closed. In addition to the aesthetic effect, this advantageously protects loaded luggage items from possibly being scratched by fastening elements of the fastening device that are arranged on the vehicle.

A quick-acting, rotating fastener can be provided as fastening device. A one-quarter, rotating, quick-acting fastener is preferably arranged for this purpose on each side wall and has a fixing point provided on the partition element and a rotating fastener which is fitted in a manner such that it is secured on the vehicle and is dimensioned in such a manner that it can be actuated easily by a hand movement. As a result, an easy installation or removal of the partition wall is possible without a tool being required for this.

A suitcase-fastener-like fastening device with a plug-in tongue is preferably provided as fastening device. In this case, a clip may be provided which is arranged on the partition element and latches into a suitcase-fastener-like plug-in tongue fitted on the vehicle. The partition wall can be fastened on the vehicle by means of a slight pulling, in a manner similar to when operating buckles of a ski trunk. A large amount of force is advantageously not required. The partition element can easily be removed again by release of the tensile connection.

A latching hook with a plug-in tongue can particularly preferably be provided as the fastening device.

Provision may be made for the partition element to be covered with a skirt, the front and rear ends of which, which run transversely to a longitudinal axis of the vehicle, are fastened in a fixed position. When the partition element is removed from the trunk space, the skirt may be annoying, or it could be crushed or damaged by the loading of items of luggage. Therefore, the skirt can preferably be detached in a region between the front and rear ends. The skirt can particularly preferably be detached by means of a zip fastener, as a result of which a part of the skirt which is not required and which covers the partition element can be removed particularly easily and rapidly.

The partition element preferably consists of plastic, for example, a thermoplastic or a duroplastic.

Other objects, advantages and novel features of the present invention will become apparent from the following detailed description of the invention when considered in conjunction with the accompanying drawings.

### BRIEF DESCRIPTION OF THE DRAWING

FIG. 1 shows a perspective view of a rear region of a convertible with a partition element according to the invention,

FIG. 2 shows a rear view of a convertible with an opened trunk lid, with the partition element removed,

FIG. 3 shows a detailed view of a fastening device for the partition element,

FIG. 4 shows a detailed view of an alternative fastening device for the partition element,

FIG. 5 shows a detailed view of a further fastening device for the partition element.

### DETAILED DESCRIPTION OF THE DRAWING

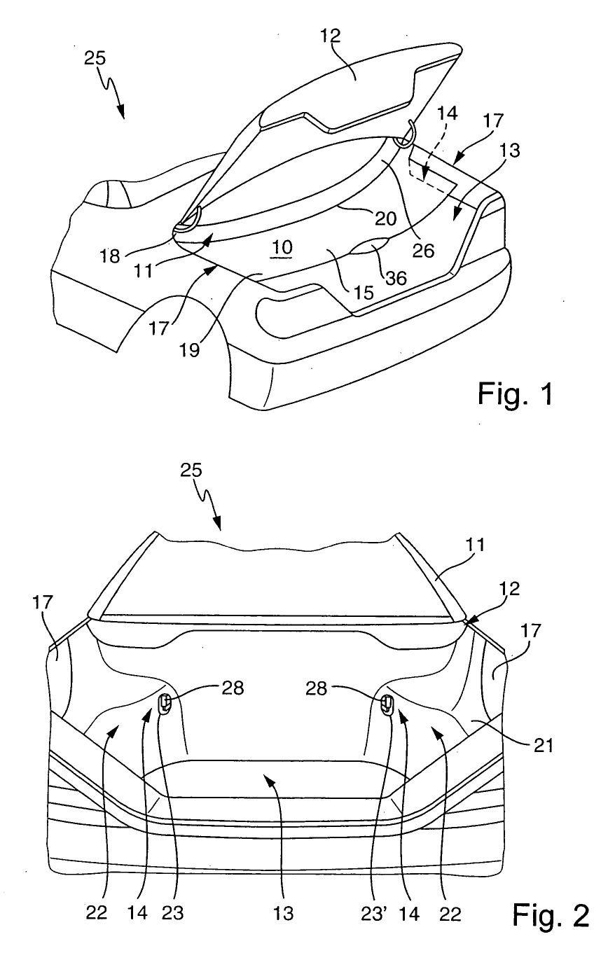

FIG. 1 shows a rear region of a convertible 25 (not illustrated specifically) with the trunk lid 12 open. Below the trunk lid 12, the convertible 25 has a folding-top compartment 26 which is used to accommodate a retractable folding top 11 when the convertible 25 is open. The folding-top compartment 26 is partitioned off from the trunk space 13 by a partition element 10 of a construction which is known per se. The partition element 10 is fastened in the trunk space 13 by means of a fastening device 14, one part of the fastening device 14 being fitted in a manner such that it is secured on the vehicle and another part of the fastening device 14 in a manner such that it is secured on the partition element. In the installed position, the fastening device 14 is arranged laterally in trunk walls 17.

In FIG. 1, the partition element 10 is in a closed state and is used for protecting the folding top 11 in its put-away state, i.e. when the convertible 25 is open. In the closed state of the partition element 10, the stowage capacity of the trunk space 13 for items of luggage and the like is considerably reduced.

In order to enlarge the usable capacity of the trunk space 13, the partition element 10 art can be displaced and can be moved into an upper position for loading the trunk space 13 and a lower position for putting the folding top 11 away. In the case of the device according to the invention, the partition element 10 can be removed from the trunk space 13 without any tools. The partition element 10 can be held more easily by means of a handle element 36.

The partition element 10 is covered with a skirt 15, the skirt 15 being fastened in a fixed position at its front and rear ends 18, 19, which run transversely to a longitudinal axis of the vehicle. When the partition element 10 is removed from the trunk space 13, the skirt 15 can be detached in a region between the front and rear ends 18, 19 by means of a zip fastener 20.

FIG. 2 shows a rear view of a convertible 25 with the trunk lid 12 open and removed. In the case of the convertible 25 in FIG. 2, the folding top 11 is closed, and the partition element 10 has been removed. A loading capacity of the trunk space 13 has therefore been considerably enlarged. When the folding top 11 is closed, the partition element 10 is also not required for putting the folding top 11 away.

Those parts 28 of the fastening device 14 for the partition element 10 which are fitted in a manner such that they are secured on the vehicle and are arranged laterally on the trunk walls 17 can be seen in FIG. 2. The trunk space 13 is provided with an interior lining 21. In a region 22 where those parts 28 of the fastening device 14 which are secured on the vehicle are arranged, the interior lining 21 has in each case an opening 23, 23′. When the partition element 10 is removed, the openings 23, 23′ leave behind unattractive holes in the interior lining 21. In addition, items of luggage could be scratched by those parts 28 of the fastening device 14 which are secured on the vehicle. For this reason, the opening 23, 23′ can be covered by a matching pocket, which cannot be seen in FIG. 2.

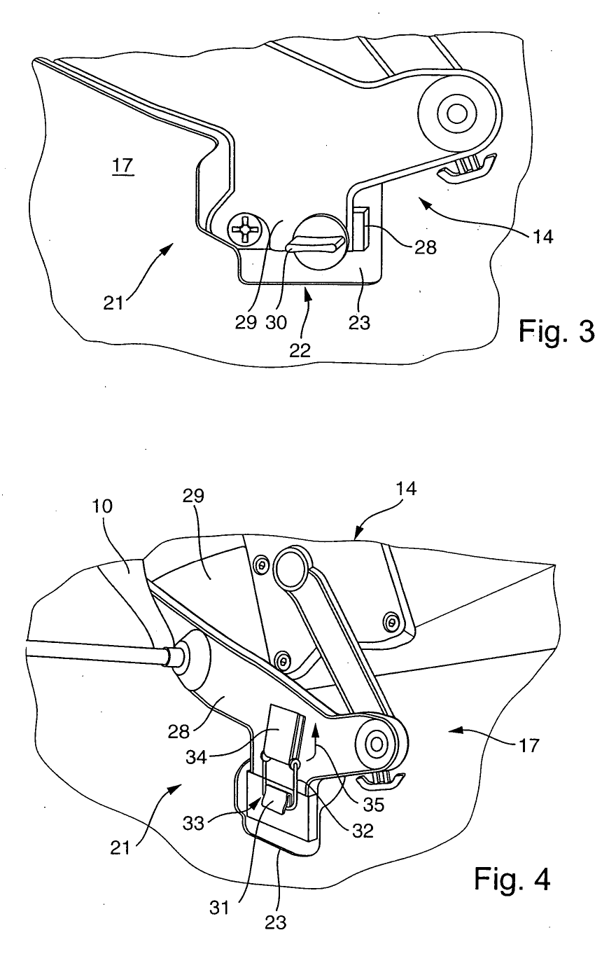

FIGS. 3, 4 and 5 illustrate detailed views of possible fastening devices 14 for the partition element 10. For the sake of simplicity, only one fastening device 14, which is arranged laterally in a trunk wall 17, is illustrated in each case. The fastening device 14 lying opposite, in the installed position, is in each case of identical construction. The fastening device 14 comprises a part 28 which is secured on the vehicle and a part 29 which is secured on the partition element. In a region 22 in which those parts 28 of the fastening device 14 which are secured on the vehicle are arranged, an interior lining 21 has an opening 23.

In FIG. 3, the fastening device 14 is designed as a quick-acting, rotating fastener with a rotating cap 30. By means of a quarter turn of the rotating cap 30 anticlockwise, that part 29 of the fastening device 14 which is secured on the partition element can be released, and the partition element 10 can be removed from the trunk space 13. The partition element 10 can be inserted again and locked just as easily.

FIG. 4 depicts a suitcase-fastener-like fastening device 14 with a plug-in tongue 31 and a clip 32. The clip 32 is connected to a buckle 34 and is arranged in a manner such that it is secured on the partition element. During the installation, the clip 32 is plugged into a latch 33 of the plug-in tongue 31. The plug-in tongue 31 is fitted in a manner such that it is secured on the vehicle. Movement of the buckle 34 in a direction 35 enables, via a tension spring (which cannot be seen), a stable connection to be produced between the partition element 10 and trunk wall 17, which connection can be released simply and easily if required.

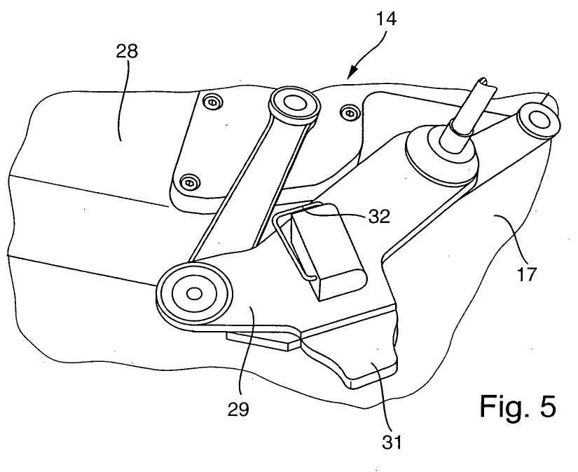

FIG. 5 shows an alternative fastening device 14 with a plug-in tongue 31 over which a clip 32 of a part 29 of the fastening device 14, which part is secured on the partition element, can be folded in order to produce a stable tensile connection between the partition element 10 and the trunk wall 17.

The fastening devices 14 which are shown can each be easily operated with one hand, thus enabling an insertion or removal of the partition element 10 to be carried out easily and rapidly.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Device for partitioning off a convertible vehicle trunk space having a folding top able to be retracted below a trunk lid, said device comprising:
a fixed partition element displaceable by at least one lever between an upper position for loading the trunk space and a lower position for storing the folding top, wherein the partition element is removeable from the trunk space by hand operation.

2. The device according to claim 1, wherein the partition element is fastened in the trunk space by a fastening device with one part of the fastening device being secured on the vehicle and another part of the fastening device being secured on the partition element.

3. The device according to claim 2, wherein the fastening device, in an installed position, is arranged laterally in walls of the trunk.

4. The device according to claim 2, wherein a quick-acting, rotating fastener is provided as a fastening device.

5. The device according to claims 2, wherein a suitcase-fastener-like fastening device with a plug-in tongue is provided as a fastening device.

6. The device according to claims 2, wherein a latching hook with a plug-in tongue is provided as a fastening device.

7. The device according to claim 1, wherein the partition element is covered with a skirt, the front and rear ends of which run transversely to a longitudinal axis of the vehicle and are fastened in a fixed position.

8. The device according to claim 7, wherein in order to remove the partition element from the trunk space, the skirt is detached in a region between the front and rear ends.

9. The device according to claim 7 wherein the skirt is detached by a zip fastener.

10. The device according to claim 1, wherein an interior lining of the trunk space has in a region in which portions of the fastening device secured on the vehicle are arranged, an opening covered by a pocket when the partition element is removed.

11. The device according to claim 2, wherein the partition element is covered with a skirt, the front and rear ends of which run transversely to a longitudinal axis of the vehicle and are fastened in a fixed position.

12. The device according to claim 3, wherein the partition element is covered with a skirt, the front and rear ends of which run transversely to a longitudinal axis of the vehicle and are fastened in a fixed position.

13. The device according to claim 4, wherein the partition element is covered with a skirt, the front and rear ends of which run transversely to a longitudinal axis of the vehicle and are fastened in a fixed position.

14. The device according to claim 5, wherein the partition element is covered with a skirt, the front and rear ends of which run transversely to a longitudinal axis of the vehicle and are fastened in a fixed position.

15. The device according to claim 6, wherein the partition element is covered with a skirt, the front and rear ends of which run transversely to a longitudinal axis of the vehicle and are fastened in a fixed position.

16. The device according to claim 2, wherein an interior lining of the trunk space has in a region in which portions of the fastening device secured on the vehicle are arranged, an opening covered by a pocket when the partition element is removed.

17. A vehicle trunk positioning device, comprising
a folding structure attached to said vehicle able to be retracted to fit in said trunk;
a fixed partition element moveable between a first and second position by a lever;
a hand-operated fastening element for removing said fixed portion element from said trunk

18. The device according to claim 17, wherein said hand-operated fastening element is a rotating fastener.

19. The device according to claim 17, wherein said fastening element in a latching hook with a plug-in tongue.

20. The device according to claim 17, wherein said fastening element is a suitcase fastener-like device with a plug-in tongue.
